(19) United States
(12) Patent Application Publication
(10) Pub. No.: US 2006/0206366 A1
(43) Pub. Date: Sep. 14, 2006

(54) Enterprise process documentation and analysis system and method

(76) Inventors: Anne Habib, Wayne, PA (US); Terry Richard Weiss, Broomall, PA (US)

Correspondence Address: RATNERPRESTIA, P O BOX 980, VALLEY FORGE, PA, 19482-0980, US

(21) Appl. No.: 11/356,656

(22) Filed: Feb. 17, 2006

Related U.S. Application Data
(60) Provisional application No. 60/653,742, filed on Feb. 17, 2005.

(51) Int. Cl. G06F 17/30; G06F 9/44; G07G 1/00; G06F 17/50

(52) U.S. Cl. 705/7; 705/10

(57) ABSTRACT

According to an exemplary embodiment of this invention a method of displaying a process characterized by multiple process steps is provided. The process comprises the step of displaying a first process flow representing the process in a flow chart format on a report, wherein the first process flow represents a first characterization of the process. A second process flow is displayed representing the process in a flow chart format adjacent the first process flow displayed on the report, wherein the second process flow represents a second characterization of the process that is different from the first characterization of the process.

### CROSS REFERENCE TO RELATED APPLICATIONS

This application claims the benefit of the filing date of the provisional application entitled ‘ENTERPRISE PROCESS DOCUMENTATION AND ANALYSIS SYSTEM AND METHOD’ filed Feb. 17, 2005 and assigned Ser. No. 60/653,742, the contents of which are incorporated herein by reference.

### FIELD OF THE INVENTION

The present invention relates to a new system and method for documenting and analyzing business or operational processes using enterprise software tools.

### BACKGROUND OF THE INVENTION

The alignment of business enterprise operations with technology has been discussed for many years. Today's environment of tight dollars, rapid change, and demands for improved productivity have outpaced the existing process analysis tools. In the globally competitive environment, organizations seek to obtain the greatest value possible from their Information Technology (IT) investments and achieve desired business results. Generally speaking, information technology must be adaptable to the operations of any enterprise for it to have value.

With regard to business or operational processes, such as, for example, payroll processing, employee hiring, and material procurement, the traditional procedure for documenting and analyzing business processes entails the manual entry of data into two separate software programs. First, the process data is entered in a narrative format using a first software tool, such as Microsoft Word™. Second, the same process data is manually entered into a second software program, such as Microsoft Visio™, to create a flow chart (or other illustration) to graphically illustrate the steps of the process. The cumbersome and time-consuming process of manually entering the same data more than once is inefficient and disadvantageous. If any change is made to the documented process, the change to the process must be updated in both software programs. Moreover, essential analysis information may be unintentionally omitted or discarded in the process of replicating data from one software tool to another. Thus, there is a need for an integrated software tool.

### SUMMARY OF THE INVENTION

The subject invention is embodied in a software tool that provides an effective means of documenting and measuring business process flows related to functions performed in an enterprise. The software tool creates process flow charts and a listing of the process flows in narrative form based on data entered into specific fields of a graphical user interface to eliminate cumbersome, time-consuming and repetitive tasks.

The software tool is also capable of generating a formalized report illustrating the intricate details of one or more states of a process. The exemplary report displays current, future, and, optionally, optimal states of a process side-by-side. Using the report, Stakeholders can quickly and easily review the state of current operations, the direction of future operations and the benefits of operating under optimal conditions.

The report is maintained in an organized and logical manner to quickly and easily communicate essential information to the reader. Return on investment (ROI) measurements and other metrics are displayed below each flow chart illustration. The report may be color-coded to illustrate the pertinent system and interface changes of the process flows. Unique color notation may be used to represent different Resources within the enterprise. Additionally the software tool highlights automation and improvement opportunities.

According to an exemplary embodiment of this invention a method of displaying a process characterized by multiple process steps is provided. The process comprises the step of displaying a first process flow representing the process in a flow chart format on a report, wherein the first process flow represents a first characterization of the process. A second process flow is displayed representing the process in a flow chart format adjacent the first process flow displayed on the report, wherein the second process flow represents a second characterization of the process that is different from the first characterization of the process.

The invention is also embodied in a method of defining a process step in a computer software program including a process matrix having a plurality of cells, wherein a series of process steps define a process flow and each process step is displayed in a row of the process matrix. The method comprises the step of entering source data into a cell of the process matrix, wherein the source data identifies the resource being utilized to initiate the process step. Action data is entered into a cell of the process matrix, wherein the action data identifies the action being performed in the process step. Resource data is entered into a cell of the process matrix, wherein the resource data identifies the resource being utilized to perform the process step. Target data is entered into a cell of the process matrix, wherein the target data identifies which resource is the beneficiary, receiver or target of the process step.

### BRIEF DESCRIPTION OF THE DRAWINGS

FIG. 1A is an exemplary narrative diagram displayed in an exemplary Report;

FIGS. 1B and 1C are an exemplary flow chart diagram displayed in an exemplary Report, wherein the flow chart diagram corresponds to the narrative diagram of FIG. 1A;

FIG. 1D is an exemplary Opportunity table displayed in an exemplary Report, wherein the table corresponds to the narrative diagram of FIG. 1A;

FIG. 2 is a schematic diagram illustrating the relationship between a Client, an Organization, and a Department;

FIG. 3 is a schematic diagram illustrating the relationship between Clients, People, Roles and Resources;

FIG. 4 is a schematic diagram illustrating the relationship between a Function, a Client, an Organization and a Department;

FIG. 5 is a schematic diagram illustrating the relationship between a Function, a Process and Process Steps;

FIG. 6 is an exemplary graphical user interface (GUI) configured for documenting a Process, referred to herein as a Process Matrix;

FIG. 7 is an exemplary GUI configured for documenting the details of each Step of a Process, referred to herein as a Process Step Editor;

FIGS. 8A and 8B illustrate another exemplary flow chart diagram;

FIG. 9 is an exemplary GUI adapted for establishing a new Client.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Referring generally to the Figures, an exemplary embodiment of a computer software tool, hereinafter referred to as Align-IT™ is described. Align-IT™ is a process documentation and reporting tool that may be utilized by any member of an enterprise or an outside consultant hired by an enterprise to document and report a process. The inventors have determined that the Align-IT™ system bestows time-efficiency and financial benefits to an enterprise by reducing process documentation time by up to 50%.

Align-IT™ is a Microsoft® Windows based system specifically designed to capture the details of a process performed by resources, human or otherwise, within a business enterprise and generate a standardized report of the process for review by the members of the enterprise (also referred to herein as Stakeholders). The Align-IT™ software tool may be utilized to document and report, for example, the organizational structure of a process, operational process flows, process-related financial controls (e.g. as required by Sarbanes-Oxley) and/or any other process. The software is adapted to capture any process ranging from a relatively simple process to an intricate process having multiple levels of complexity. Although the examples provided below may describe the invention in terms of processes performed by health care workers, it should be understood that the application of this software spans all industries and is intended for use by any enterprise seeking to document and/or report any process.

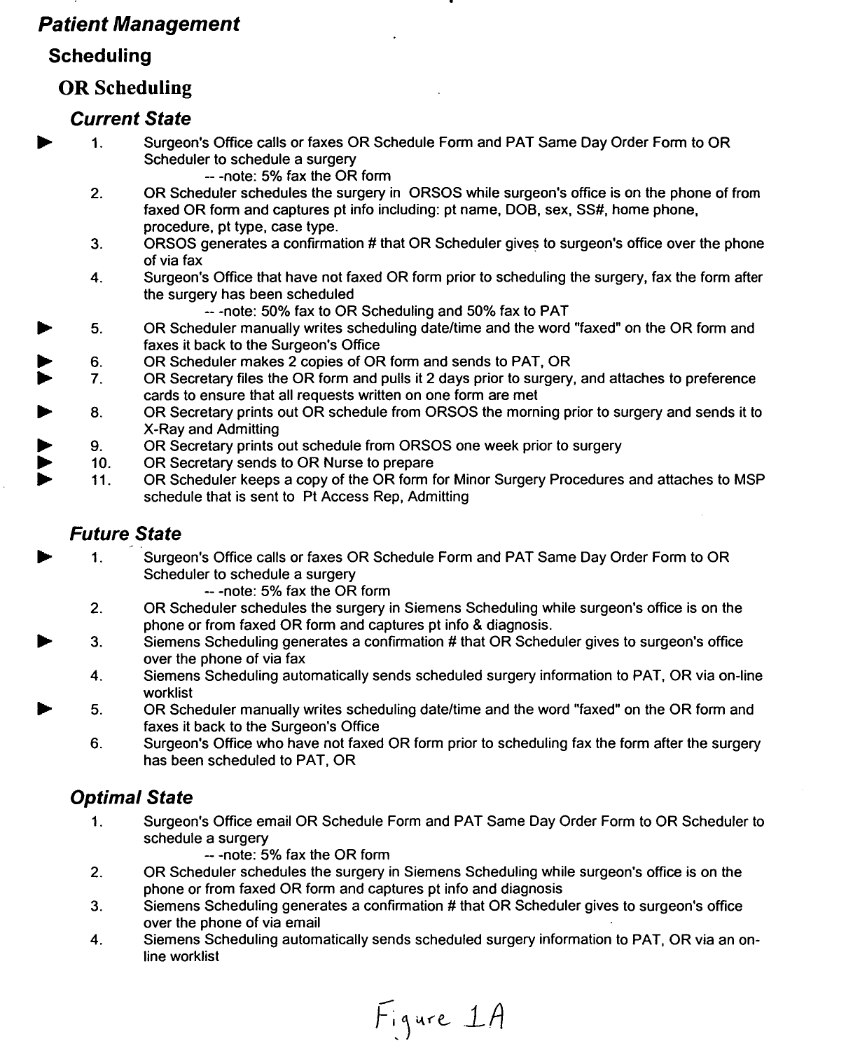

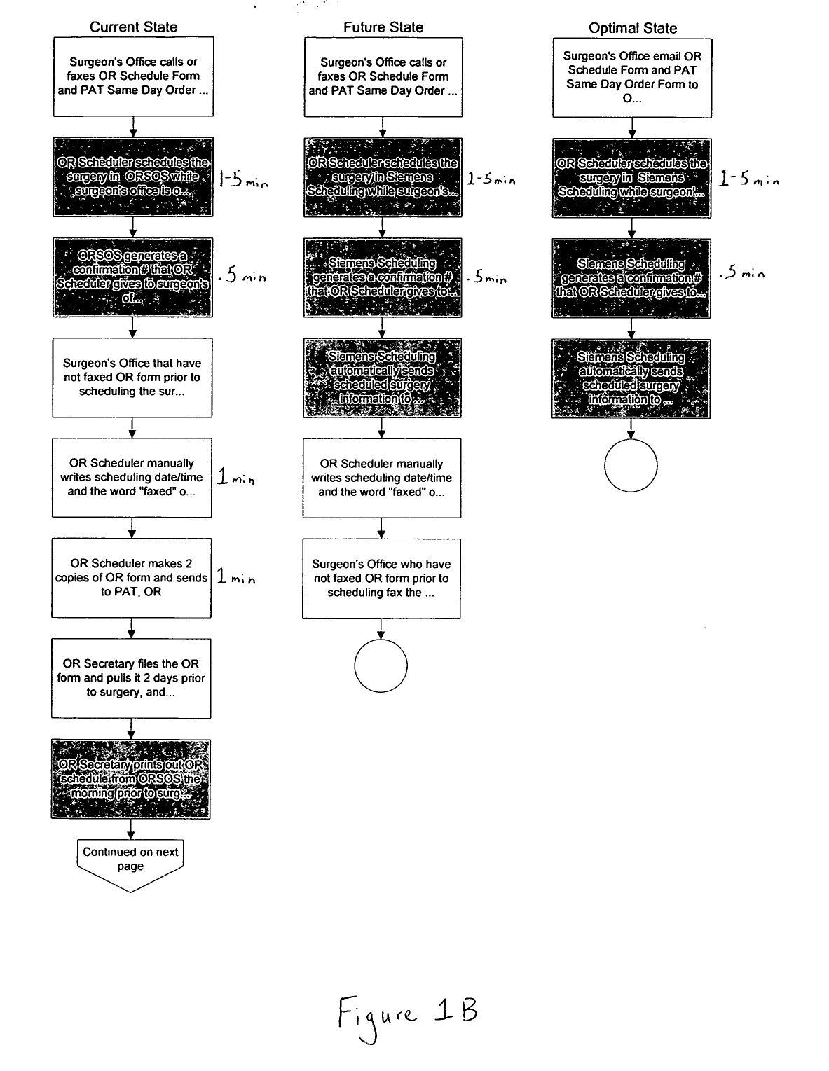

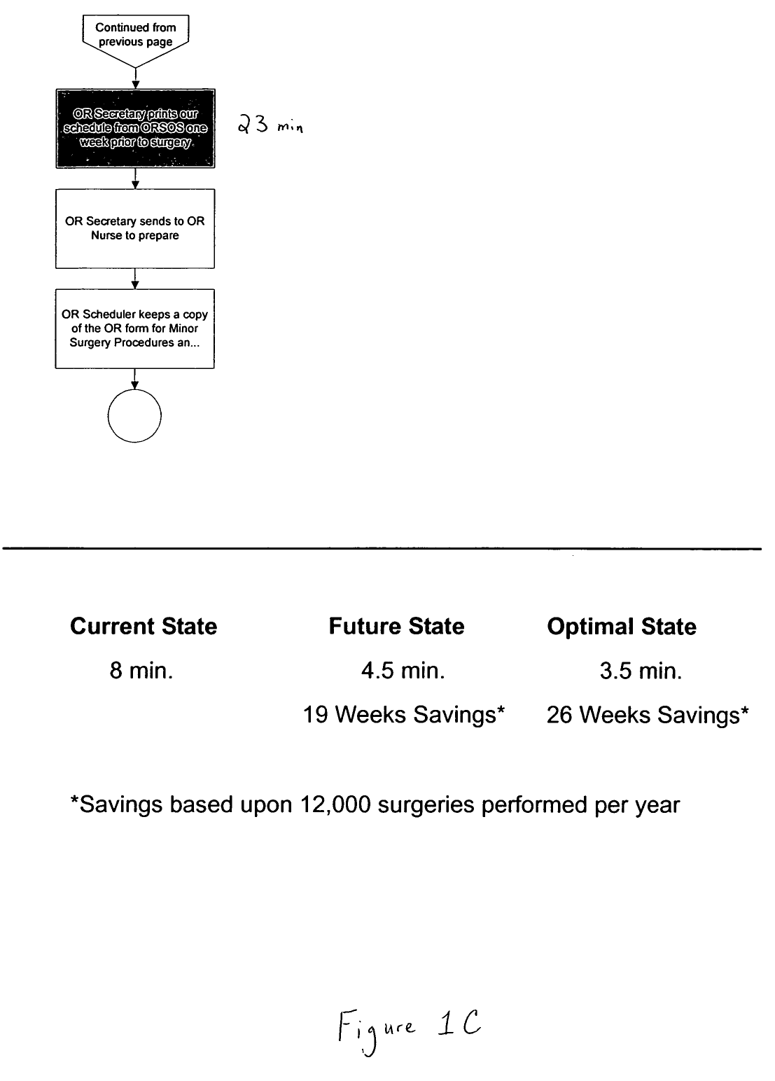

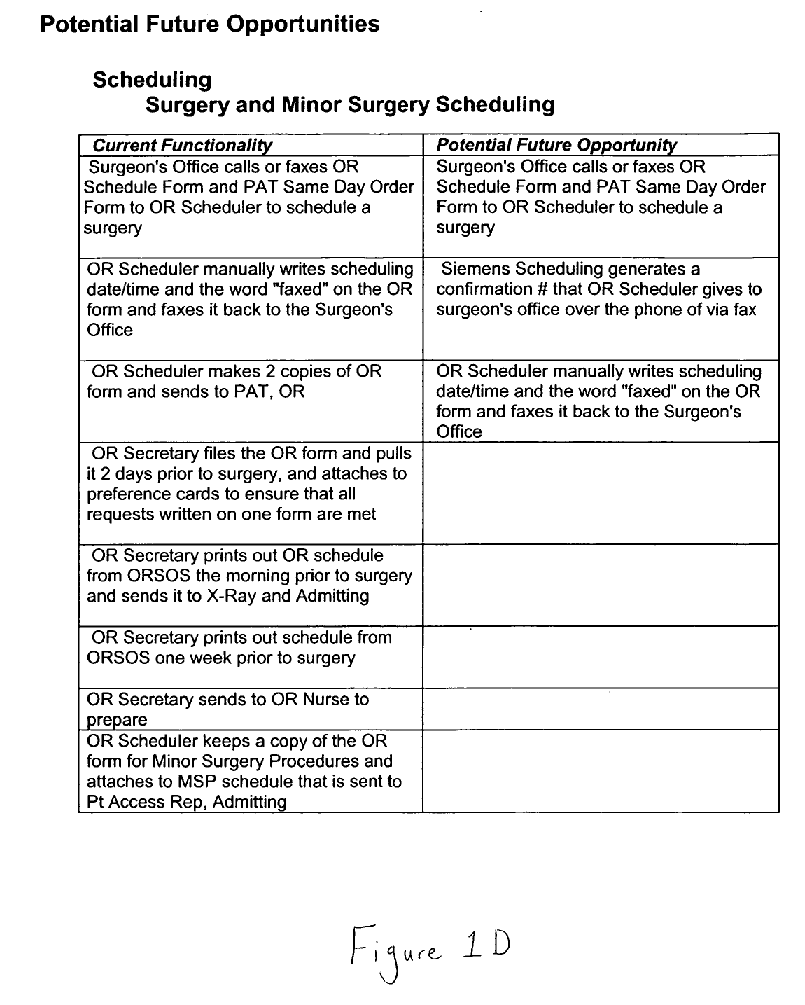

The Align-IT™ system is capable of generating a formalized report which includes a narrative section, a flow chart and a table illustrating the intricate details of one or more processes. An example of a report is illustrated in FIG. 1A (narrative section), FIGS. 1B and 1C (flow chart) and FIG. 1D (table). The report may be beneficial to any enterprise for the purposes of analyzing an existing process, recognizing opportunities for process improvement, comparing an existing process to other processes, and comparing an existing process with an optimal process. Upon reviewing a report, an organization may change an existing process or adopt a new process. The report is also referred to herein as a ‘deliverable’, because the report is essentially a product submitted to a Stakeholder for review.

The narrative section of the report, which is optionally generated by a Microsoft® Word application, lists the intricate details of each step of a process in prose format. An example of a narrative section is illustrated in FIG. 1A. The flow chart section of the report, which is optionally generated by a Microsoft® Visio application and embedded into the Microsoft® Word document, illustrates the various steps of the process in graphical form. The flow chart includes information from the narrative section together with operational metrics. The flow chart is useful for directly comparing alternative processes, which are described in greater detail below. An example of a flow chart is illustrated in FIGS. 1B and 1C. The Opportunities table identifies opportunities for automating steps of a current process. An example of an Opportunities table is illustrated in FIG. 1D.

In practice, a user first enters information into the Align-IT™ software tool to define the detailed hierarchy of an enterprise. More specifically, the user creates a logical hierarchy comprising (in descending order) a Client (e.g., the United States Government), an Organization (e.g. United Stated Patent and Trademark Office), a Department (Patent Office), People (e.g. Examiner John Doe), Roles (e.g. Patent Examiner Corps), and Resources (e.g. Unix server).

A Client is defined as any entity that requests an analysis of a process. Organizations represent, generally, a specific division, location, or other logical subset of a Client. Departments define specific groups within Clients and/or Organizations, such as Accounting, Human Resources or Information Technology (IT). Roles represent a group of People that perform specific Functions or participate in Processes. Resources are available to the Client, Department or Organization to be a participant or potential participant in a Process or Function. The user uniquely defines the relationships between the above entities using the Align-IT™ software. The software tool provides a linking feature, such as an icon or a ‘drag and drop’ feature to facilitate the creation of these hierarchal relationships.

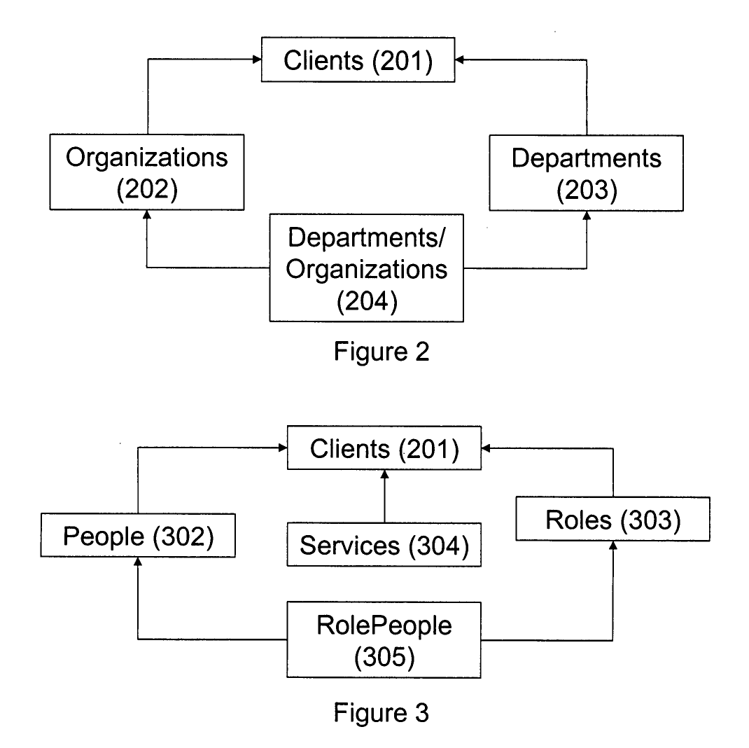

FIG. 2 illustrates the hierarchical relationship between the Client (201), Organizations (202), and Departments (203). A Client is shown as having Organizations and Departments. Organizations are subsets of Clients. For instance, if a Client operates several hospitals, each hospital would be an Organization of the Client. The construct ‘Departments/Organizations’ (204), addresses the various relationships that Departments and Organizations may have. For instance, some Departments of Clients are located only at a specific Organization, whereas other Departments may span Organizations of a Client. The user of the software tool uniquely defines these relationships using the software tool.

FIG. 3 illustrates the hierarchical relationship between Clients (201), People (302), Roles (303) and Services (304). Services may also be referred to as Resources. To address the WHO, WHAT and WHERE of any process, the system defines People, Roles and Resources, respectively. People, Roles and Resources are all subsets of Clients. Although not illustrated, People, Roles and Resources may also be subsets of Departments and/or Organizations. The construct‘RolePeople’ (305), addresses the various Roles People play in a Process, Function or at an Organization or Department. For instance, People may play more than one Role and Roles can include many People. Again, the user of the software tool uniquely defines these relationships using the software tool.

After the aforementioned hierarchy of an enterprise is established, the user enters information into the Align-IT™ system to define the details of a Function. A Function is a general description of an act or operation that comprises multiple Processes, such as ‘Examine Patent Application’, ‘Hire New Employee’, ‘Schedule a Surgery’, or ‘Balance a Checkbook’. For example, the Function of ‘Hire New Employee’ comprises the Processes of (1) providing the new employee with a computer and (2) assigning the new employee to an office.

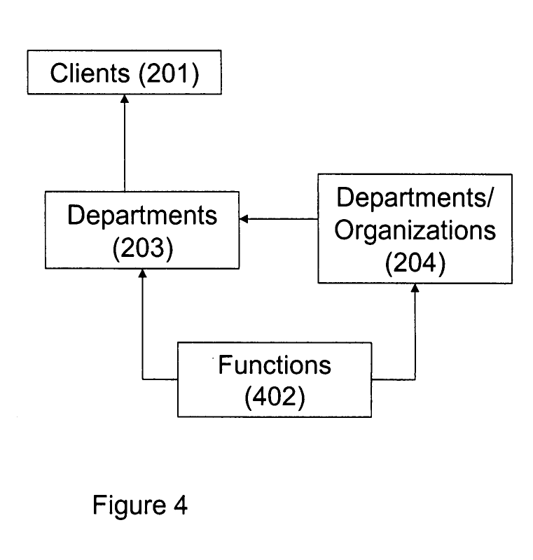

FIG. 4 illustrates the relationship between a Function (402), a Client (201), a Department (203), and a Department/Organization (204). Functions are associated with either a Department or a Department/Organization but not both. For example, only the Accounting Department of an Organization can perform the Function of ‘File a Tax Return’. The user of the software tool uniquely defines these relationships using the Align-IT™ software tool.

Referring specifically to the exemplary Align-IT™ software tool, a graphical user interface (GUI) utilized to establish a Client is illustrated in FIG. 9. In this GUI, the user selects the icon ‘Create Client’ (901) to create a new Client and then manually enters the name of the Client into a text box (902), or, alternatively the user may select the icon ‘Open Client’ (903) to access a listing of existing Clients stored within the system. Departments, Organizations, People, Roles, Functions and Resources are established within similar GUI's. As mentioned above, the software tool provides a linking feature, such as an icon or a ‘drag and drop’ feature to facilitate the creation of the hierarchal relationships among the Client, Departments, Organizations, People, Roles, Functions and Resources.

After the enterprise hierarchy is established, the user enters information into the Align-IT™ system to define the details of one or more Processes. Processes are defined as sequences of operations that conclude with a intended or anticipated result. A Process generally comprises one or more Process Steps. Typically, although not exclusively, Processes have an input state and an output state. The following example is provided to illustrate how a Function, Process, and Process Steps are interrelated. A user defines a Function, e.g. ‘Hire New Employee’, one or more Processes e.g. ‘Prepare for Arrival of New Employee’, and one or more Process Steps, e.g. ‘Place Order for New Computer for New Employee’, ‘Receive Computer’ and ‘Setup Computer for New Employee’.

Process Steps may be linked together in any variety of ways as prescribed by Boolean logic, which is well known in the art. For example, a process may merely encompass a series of sequential Process Steps, e.g., Step A then Step B then Step C then Step D. Alternatively, a Process may encompass a more complex series of Process Steps, e.g. if Step A then Step B, if Step B then Step C and Step D, if Step D then Step E or Step F. The technique of arranging the Process Steps is described in further detail below.

Each Process Step is desirably associated with at least one Process State. The software tool is able to accommodate multiple Process States, such as a Current Process State, a Future Process State and an Optimal Process State. Briefly, a Process State refers to the condition under which a Process is performed. In one exemplary embodiment, a Current Process State represents a process that is performed under existing or current conditions, a Future Process State represents a process performed under different conditions than the Current Process State, and an Optimal Process State represents a Process performed under optimal conditions, that is to say with optimal process steps and resources.

The Future State of a Process represents a change or series of changes to the Current State of the Process. In practice, a user defines a Future State to answer a question, such as, ‘what is the result if I change the conditions of a Current Process?’ Furthermore, the Optimal State of a Process represents a Process conducted under best industry practice standards, automation or new system functionality. In practice, a user defines an Optimal State to answer the question of ‘what is the result if I perform the Process under optimal conditions?’

The various Process States are generally utilized so that the end user or client can compare the states against one another to determine an appropriate course of action. By way of non-limiting example, a Current Process State may define a series of Current Process Steps, such as ‘Order New Computer By Mail’, ‘Complete Order Form’, ‘Send Payment’, ‘Receive New Computer’, and ‘Setup New Computer’. Yet an Optimal Process State may define an Optimal series of Process Steps, such as ‘Order New Computer Via the Internet’, ‘Receive New Computer’, and ‘Setup New Computer’. Using this example, the Process Step ‘Setup New Computer’ has both a Current and Optimal Process State, whereas the Process Step ‘Complete Order Form’ has only a Current Process State. It should be understood that each Process Step is associated with at least one Process State. The Process States are described in more detail below.

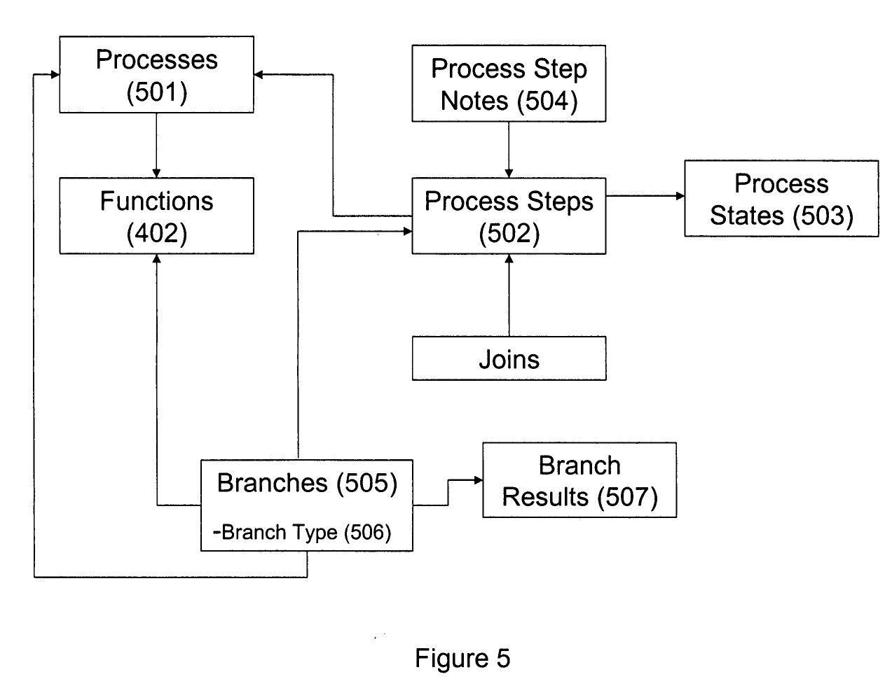

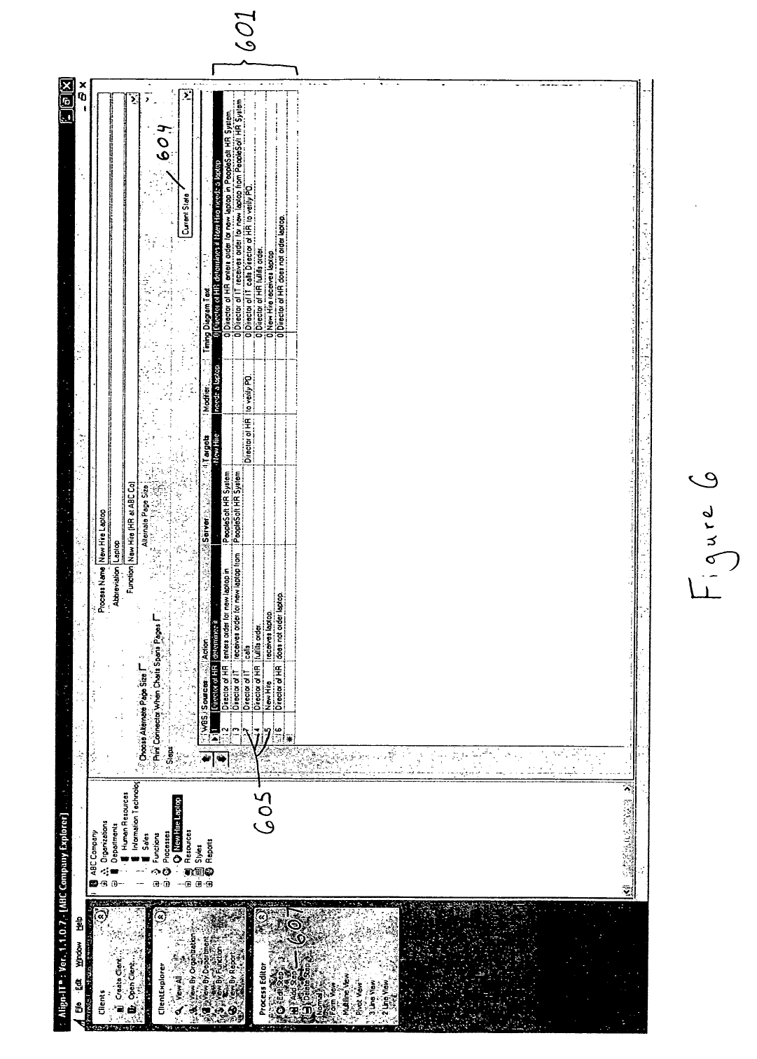

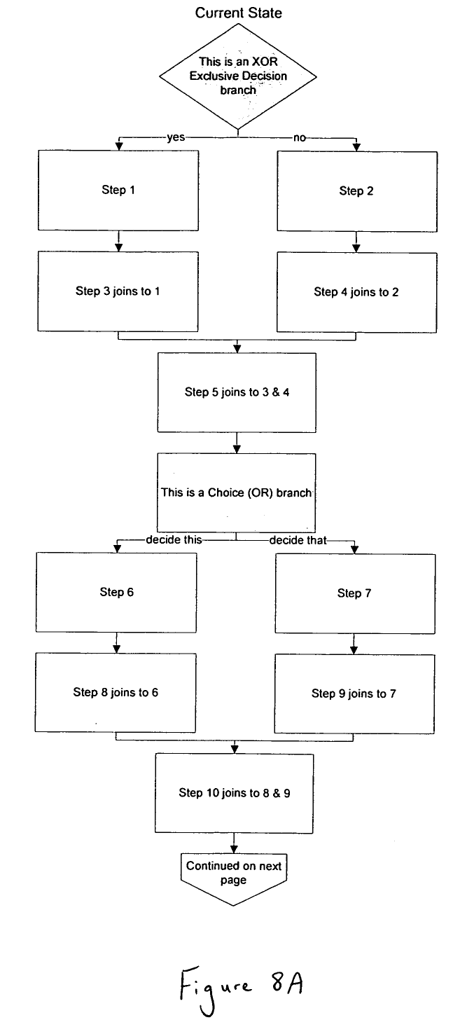

FIG. 5 illustrates the unique relationship between a Function, Process and Process Steps, according to one exemplary embodiment. As illustrated in FIG. 5, a Process (501) is a subset of a Function (402) and a Process Step (502) is a subset of a Process (501). In the exemplary embodiment of the invention, the construct ‘Process States’ (503) defines the status of a Process. According to this exemplary embodiment, Legal values of the Process States are limited to Current, Future and, optionally, Optimal. The construct ‘Process Steps’ (502) represent the Steps of the Process. The construct ‘Process Step Note’ (504) is associated with each Process Step to further describe the purpose of the Process Step. As described in detail below, a user enters natural language text into the GUI illustrated in FIG. 7 to define the Process Step Notes. The construct ‘Branches’ (505) specifies conditions in the Process and/or Function that branch a Process Step. The construct ‘Branch Types’ (506) refers to the conditions and reasons for each branch of a Process Step. The construct ‘Branch Results’ (507) refers to the types of actions that a branch can provide. In this embodiment, the legal values of Branch Results are Function, Process, Step, Terminate or Other. More specifically, Function indicates that the Process Step branches to a Function, Process indicates that the Process Step branches to a Process, Step indicates that the Process Step branches to another Process Step, Terminate indicates that the Process Step is the final step of a process, and Other indicates that the Process Step branches to another branch. The user of the software tool uniquely defines these relationships using the software tool.

The Align-IT™ system is particularly advantageous because the system induces the user to break down a Process Step into its most basic elements. More specifically, Align-IT™ prompts the user to address at least the following questions related to each step of a Process: (1) who performs the process step, (2) where is the process step performed, (3) when is the process step performed, (4) how long does it take to perform the process step, (5) from where does the information to complete the process step come, (6) where does the information to complete the process step go, (7) are there alternatives to complete the process step, (8) what potential optimizations exist to complete the process step, (9) what steps of the process can be automated, and (10) if there are dependencies between processes, what are they? The answers to these questions define each Step of a Process. By structuring data using this methodology, users are compelled to document Process Steps in a comprehensive, logical and natural fashion. Moreover, this methodology causes a user to recognize each individual Step of a Process, thereby avoiding the common pitfall of inadvertently combining multiple steps and omitting critical information.

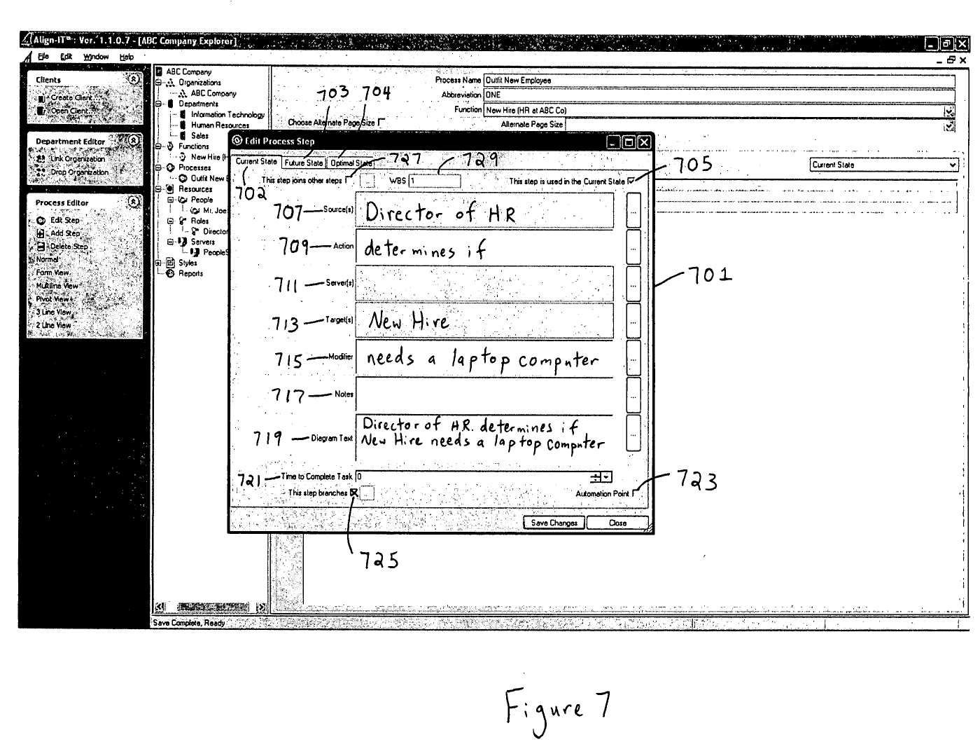

Referring specifically to the Align-IT™ software tool, the user is prompted to address each of the above Process Step related questions in a contextually structured graphical user interface, hereinafter referred to as a Process Matrix. An exemplary embodiment of a Process Matrix is shown in FIG. 6. The Process Matrix is referred to as a contextually structured graphical user interface because text is entered into fields of the Process Matrix in a structured manner as to define a Process. Referring to FIG. 6, a series of Process Steps (605) is displayed in the Process Matrix (601). As explained above, a Process is generally comprises a series of Steps, accordingly the Process Matrix organizes a series of Process Steps. Each of the Process Steps (605) is separately listed in sequential order along the rows of the Process Matrix (601). The Column terms (i.e. Sources, Action, Server, etc.) are described below with reference to the Process Step Editor. The Current State of the Process is illustrated in the Process Matrix, as shown in FIG. 6. The Future or Process State may be illustrated in the Process Matrix if the drop-down menu (604) is changed from Current State (as shown) to either the Future or Optimal State.

Referring now to FIG. 7, a Process Step Editor GUI is linked to the Process Matrix. Because a Process comprises a series of Steps, the Process Matrix is created by defining individual Process Steps and the Process Steps are created using the Process Step Editor. In other words, the rows of the Process Matrix shown in FIG. 6 are populated by defining each Process Step in the Process Step Editor shown in FIG. 7. The Process Step Editor is directly linked to the Process Matrix, such that any additions, deletions or changes made to the Process Step Editor are automatically populated or updated in the Process Matrix.

In practice, the user selects the icon labeled ‘Add Step’ (607) illustrated in FIG. 6 to add a new step to the Process matrix. The Process Step Editor GUI then appears on the screen, as shown in FIG. 7. According to this exemplary embodiment, the user first designates a Process State, i.e. either Current, Future or Optimal, by selecting one of the three window tab icons (702, 703, 704) located on the top left hand corner of the Process Step Editor Window (701). To assign a Process Step to a Process State, the user then selects the check-box (705) located in the top right hand corner of the Process Step Editor Window (701). Moreover, if the Future State window tab is selected, the text adjacent to check-box 705 states ‘This step is used in the Future State’ and, if the Optimal State window tab is selected the text adjacent to check-box 705 states ‘This step is used in the Optimal State’. Similarly, to activate the Future and/or Optimal Process Steps, the respective check-boxes must be selected. This feature is described in more detail below.

In the exemplary system, the user selects one or more ‘Source(s)’ (707) of the Process Step from a drop-down menu. A Source is any entity that initiates, carries out or completes a Process Step. The Source is limited to any previously defined Person, Role, Organization, or Department. In this example, the Source of the Process Step is a Director of Human Resources (HR), which is a Role.

The user then manually enters text into the ‘Action’ text box (709). An ‘Action’ is generally performed by the Source(s) of the Process Step. The ‘Action’ may be any natural language phrase containing a verb, such as the phrase ‘determines if’ shown in FIG. 7. It should be understood that an ‘Action’ is not dependent upon any previously entered data.

The user then selects one or more ‘Server(s)’ (711) from a drop-down menu of previously defined Resources. A Server may refer to an electronic computer Server, or the Server may represent any other enterprise Resource such as a Facsimile machine or Copy Machine which is utilized to perform the Process Step. The Server is limited to any previously defined Resource described above. In this exemplary Process Step shown in FIG. 7, however, a Server is not utilized.

The user selects one or more ‘Target(s)’ (713) of the Process Step from a drop-down menu. A Target is defined as an entity upon which the Process Step acts. The Target is limited to any previously defined Person, Role, Organization, or Department. In this example, the Target of the Process Step is a New Employee (i.e. New Hire) and the Process of determining if the New Employee needs a computer acts upon the New Employee.

The user then manually enters text into the ‘Modifier’ text box (715). The ‘Modifier’ may be generally referred to as a predicate modifier. Predicate modifiers typically qualify a predicate, limit or set conditions or circumstances on a predicate, or indicate reasons, conditions, manner or time. The Modifier may be any natural language phrase, such as the phrase ‘needs a laptop’ shown in FIG. 7.

The user can manually enter any arbitrary natural language notes in to the ‘Notes’ text box (717). For example, a Note may be an detailed explanation of the Process Step. Although in this example, a Note is not included. The Note is not included in the Report that is generated by the software tool.

Another feature of the Process Step Editor window is the ‘Diagram Text’ box (719). As the user enters information into the Source(s), Action, Server(s), Target(s) and Modifier text boxes, that information automatically appears in the ‘Diagram Text’ box (719). The Diagram Text box may be used to visually observe the creation of the Process Step in real-time. As illustrated, the Diagram Text box (719) shows the entire phrase of the Process Step, namely ‘Director of HR determines if New Hire needs a laptop computer.’ This phrase is conveyed to the Report, as described in more detail below.

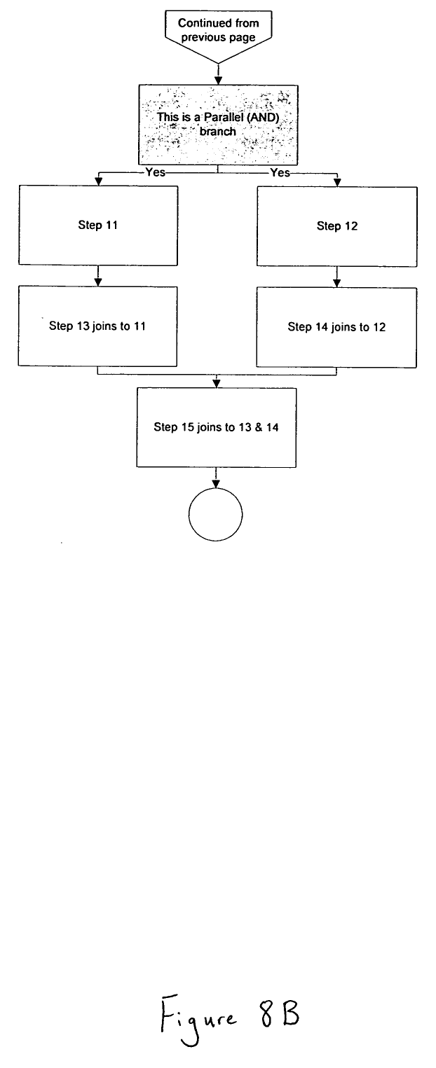

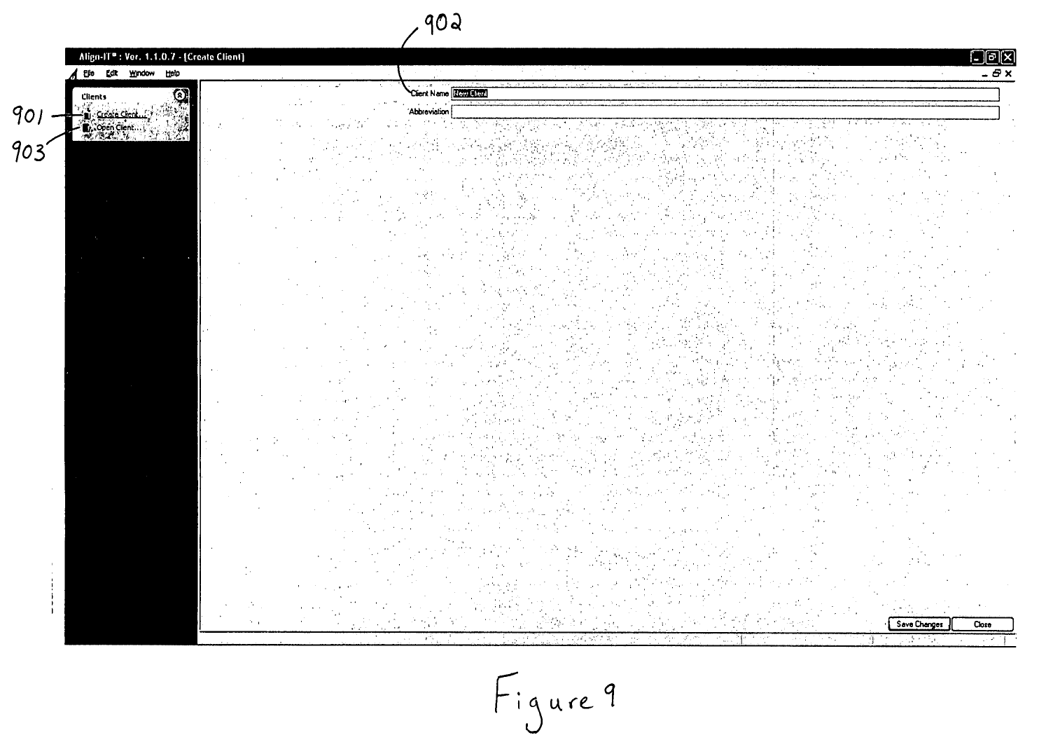

The user may enter the time to complete a Process Step into the ‘Time to Complete Task’ text box (721) shown in FIG. 7. In practice, the software tool totals the recorded times of each Process Step and displays the total time to complete the entire Process in the Report, as shown in FIG. 1B. The summation of the time values may be referred to as a time metric. However, if the Process Steps are branched, such as the Process illustrated in FIGS. 8A and 8B, the software tool averages the branched time values to calculate the total time to complete a Process. The time metric is described in more detail below. Although not shown, the software is also adapted to automatically enter a time through XML files or other means stored on an enterprise system.

The check-box labeled ‘Automation Point’ (723) is provided at the bottom right hand corner of the Process Step Editor window shown in FIG. 7. In practice, the user selects the Automation Point box if the user believes the Process Step is capable of being automated. This feature is described in further detail with reference to the Report.

The check-box labeled ‘This step branches’ (725) may be selected, as shown, to indicate that the particular Process Step branches into more than one subsequent step. Although not illustrated, another window appears prompting the user to define the details of the branch (e.g. if the answer to a particular question is ‘Yes’ then Proceed to Step 1, otherwise proceed to Step 2). The check-box ‘This step joins other steps’ (727) may be selected to indicate that the Process Step joins with one or more subsequent Process Steps. Although not illustrated, another window may appear prompting the user to define the joining of steps (e.g. Step 5 joins to Step 3 and 4). The user establishes the order of the Process Steps by entering the step order into the ‘WBS’ text box (729) shown in FIG. 7. In the example shown in FIG. 7, the Process Step is set to 1, signifying that this Process Step is the first step of the Process.

An example of a flow chart illustrating a series of 15 interconnected Process Steps is shown in FIGS. 8A and 8B. Three different varieties of branch operators are shown, i.e. OR, AND, and Exclusive OR (XOR). As mentioned above, the branching methodology follows Boolean logic. For example, as shown in FIG. 8A, following Step 5, a client chooses between two options, one of which proceeds to Step 6 and the other proceeds to Step 7, or proceeds to both Step 6 and Step 7 in parallel.

In practice it is not mandatory that all of the text boxes, check-boxes and drop down menus illustrated in FIG. 7 be completed or selected. Rather, the user may tailor each Process Step to her unique set of requirements. Furthermore, it is not required that the text boxes and drop down menus of the Process Step Editor window be completed in any particular fashion or order.

A Process Step can be affiliated with one, two, or all of the exemplary Process States. In one exemplary embodiment, the software may be configured to automatically generate a Future and Optimal Process Step as the user creates the Current Process Step. Of course, it should be understood that the automatically generated Future and Optimal Process Steps include the same information and menu selections as the Current Process Step until the user uniquely tailors the Future and Optimal Process Steps. In other words, until the user manually modifies the automatically generated Future and Optimal Process Steps, those Process Steps are no different than the Current Process Step. This feature of the software tool is beneficial from an efficiency perspective if the Future and Optimal Process Steps are similar to the Current Process Steps. By virtue of this time-saving feature, the user is not required to repeat the time-consuming task of re-entering data into the Future and Optimal Process Step GUI's after the Current Process Step has been created.

Although Align-IT automatically generates the Future and Optimal Steps as the user creates the Current Steps, the Future and Optimal Steps must be formally activated by the user. As explained previously, to activate a Future or an Optimal Process Step, the check-box (705) stating ‘This step is used in the Future State’ (not shown) is selected to activate a Future Process Step and the check-box (705) stating ‘This step is used in the Optimal State’ (not shown) is selected to activate an Optimal Process Step.

Alternatively, in another exemplary embodiment, standard Optimal Process Steps may be available in a consolidated database or library that may be accessed through a drop down menu in the software tool. A standard Optimal Process Step is an Optimal Process Step that is frequently utilized in Optimal Processes throughout an Organization. By virtue of this time-saving feature, the user is not required to recreate a pre-existing Optimal Process Step. The library may be, for example, deployed in an ASP (Application Service Provider) environment using web-based technologies. The library may contain information related to relevant laws and regulations such as Sarbanes-Oxley, Health Insurance Portability and Accountability Act (HIPAA) or controlling bodies such as the Joint Commission on Accreditation of Healthcare Organizations (JCAHO).

As mentioned previously, after each Process Step is defined in the Process Step Editor GUI, the data is automatically updated in the Process Matrix.

Referring now to the Reporting functionality of Align-IT™ , Align-IT™ is configured to process the data within the Process Matrix to generate a Report. The Report, which may also be referred to as a deliverable, is a unitary document that illustrates the essential elements of a Process having one or more Process States. The deliverable is useful for the presentation, evaluation and ongoing management of a business or operational process. The Report serves as a road map to track the changes from the current operational environment to the future operational environment. The Report can help an enterprise identify deficiencies of an existing process and highlights the benefits of a newly proposed process. A Report generally comprises at least a narrative section listing the process steps in prose format, a flow chart illustrating the essential elements of at least one Process and a table illustrating the opportunities to enhance a Process.

Existing software tools do not display current, future and optimal states of process flows side-by-side for the purposes of comparison. If the display of distinct process flow states are separated, users of the software tool are not able to visually recognize the changes between various process flow states. This may result in confusion as to what has actually changed, how to address those changes, and how to leverage automation opportunities, enhanced system functionality, and reengineered business processes.

A Report, such as the Report illustrated in FIGS. 1A-1D, is generated by the user to display the Current, Future and Optimal states side-by-side for comparative purposes. As explained previously, the Future State of a process may represent a change to a Current State and an Optimal State of a process may represent how a process is performed by applying industry best practice or leveraging improved system functionality, for example.

The Process is illustrated in a narrative or prose format in the Report, as shown in FIG. 1A. Each Step of the process is listed in descending order. Automation indicators are shown to the left of the Process Steps in the form of arrows. The automation indicators are set by the user in the Process Step Editor (refer to check box 723 illustrated in FIG. 7).

The Process is also illustrated in a color coded flow chart format in the Report, as shown in FIGS. 1B and 1C. The text displayed in the color coded flow charts is equivalent to the text displayed in the narrative section of the Report. Each Process State is displayed in columnar format. As stated above, the Process States are displayed side-by-side because it is easier to compare the Process States if they are illustrated directly adjacent one another. The name of each Process State is displayed above each of the flow charts. A time to complete the Process Step, defined by the user, is displayed to the right of many Process Steps. The time and Return on Investment (ROI) metrics are displayed beneath the flow charts illustrated in FIG. 1C. The significance of these metrics is described in further detail in the Example section below.

The Report also includes an Opportunities table, an example of which is shown in FIG. 1D. The automation Opportunities for the Current and Future States are displayed in the ‘Current Functionality’ and ‘Potential Future Opportunity’ columns of the table, respectively. It should be understood that the ‘Current Functionality’ column entries correspond with the automated steps of the Current State shown in FIG. 1A, i.e., the Current Process Steps having automation arrows are listed in this column of the Opportunities table. Similarly, the ‘Potential Future Opportunity’ column entries correspond with the automated steps of the Future State shown in FIG. 1A, i.e., the Future Process Steps having automation arrows are listed in this column of the Opportunities table.

The Process Matrix and the Report are integrated features of the Align-IT™ System. More specifically, any changes made to the Process Matrix are automatically updated to the Report. For example, if the user modifies a Process, such as by editing a Process Step, adding a Process Step or adding a Process State, the user first modifies the Process Matrix through the Process Step Editor. The user then generates a Report. By virtue of the integrated Report, the changes made to the Process Matrix are automatically communicated to the Report, such that all three sections of the Report display the latest changes made to the Process Matrix. In contrast, using the conventional process documentation and reporting tool described in the Background section, the user is forced to manually modify both the narrative section of a report and the flow chart section of a report. Thus, this software tool represents a significant time-savings over the conventional process documentation and reporting tool and produces more consistent results.

The exemplary system is a Windows® Forms based application. To the end user, the main paradigm is the Explorer with a task pane, tree view and dialogs presented for details, as shown in FIG. 9. The end user is expected to be non-technical, but familiar and comfortable working with Windows applications and conversant with the concepts and terminology of business process modeling. The system permits the user to explore and navigate all aspects of a process or series of processes defined for a Client.

### EXAMPLE

The following example illustrates the operation of the Align-IT™ system in the context of a scheduling of a minor surgery in a hospital. The example applies the exemplary embodiment of the invention, described above, to answer three questions:
1. How does the Scheduling department of a hospital operate today?
2. How does the current information technology system(s) support the Scheduling department?
3. How can new patient scheduling system technology improve operations and achieve desired business results?

As a first step to ensuring that the implementation of new technology will support and improve scheduling operations, the current patient scheduling process using the existing patient scheduling system is documented in the Process Matrix of the Align-IT™ system. General automation opportunities are identified prior to selecting a new patient scheduling system and recorded in the Process Step Editor. Once a new patient scheduling system has been selected, a future state of the patient scheduling process is developed using the constraints of the new scheduling system.

The scheduling process for a minor surgical operation is illustrated in FIGS. 1A-1C. In this example, the Current State of the patient scheduling process entail the following steps: first, the surgeon's office calls or faxes the operating room (OR) Schedule Form and PAT (Patient Admission Testing) Same Day Order Form to OR Scheduler to schedule a surgery. (Typically about 5% of surgeon's offices fax the OR form). As a next step, the OR Scheduler schedules the surgery in the ORSOS scheduling system while the surgeon's office is on the phone or from the faxed OR form and captures patient information including: patient name, DOB, Male/Female, SS#, home phone, procedure, patient type, and case type. The ORSOS system then generates a confirmation number that the OR Schedule provides the surgeon's office over the phone or via fax. The surgeons' offices that have not faxed the OR form prior to scheduling the surgery then must fax the OR form after the surgery has been scheduled. (Typically about 50% of the surgeons' offices fax the OR form to OR Scheduling and 50% of the surgeons' offices fax the form to PAT). The OR Scheduler then manually writes scheduling date/time and the word ‘faxed’ on the OR form and faxes it back to the surgeon's office. Next, the OR Scheduler sends the OR form to PAT and OR. The OR Secretary then files the OR form and attaches the OR form to preference cards to ensure that all requests written on form are met two days prior to surgery. The morning prior to surgery, the OR Scheduler prints out the OR schedule from ORSOS and sends it to the X-Ray department and the Admitting department. The OR Scheduler prints out the schedule from the ORSOS one week prior to surgery and sends the schedule to the OR Nurse to allow her or him to prepare. The OR Scheduler keeps a copy of the OR form for Minor Surgery Procedures (MSP) and attaches to the MSP schedule that is sent to the Patient Access Rep in Admitting.

The exemplary Report produced by the Align-IT™ system illustrates how this process can be simplified in a Future and Optimal state. As shown in FIGS. 1A-1C, the Future and Optimal States of the patient scheduling process entail fewer steps than the Current State of the patient scheduling process using the Siemens software system. The Report also shows the time savings of each of these states relative to the Current State in the box at the bottom of FIG. 1C. These time values are calculated as follows: each step in a process is timed to determine a number of minutes it takes to perform each specific task. Next, the number of minutes is added to calculate totals for each state—current and future. The total number of minutes used in the current state is subtracted from the total minutes used in the future state to calculate a difference. The difference is then multiplied by a number of occurrences of the process during a year as identified by the client or system. This calculation is divided by 60 (minutes) to calculate a total number of hours and the total number of hours is divided by 40 (i.e. 40 hours/work week) to calculate the total number of weeks. This is the number of weeks per year that would be saved by performing process in the future state. If the system provides for an Optimal state, as shown, the above calculation is repeated substituting the optimal state for the future state. The calculated results are displayed to allow the user to compare the return on investment (in the form of time) across the states to articulate savings for future state and, optionally, the optimal state.

The invention may be implemented in computer software that may be run on a general purpose computer. The software may reside on a computer readable carrier such as a magnetic or semiconductor memory device, a magnetic or optical disc or a radio-frequency, audio-frequency or optical carrier wave.

While exemplary embodiments of the invention have been shown and described herein, it will be understood that such embodiments are provided by way of example only. Examples provided may describe the invention in terms of processes performed by health care workers, however, the application for this software spans all industries and is intended for use in any process intensive enterprise. Numerous variations, changes and substitutions will occur to those skilled in the art without departing from the spirit of the invention. For example, although the Process Matrix is shown in a row-column format, the Process Matrix may be structured in any way known in the art. Furthermore, although the Report illustrates the Process States in column format, the Process States may be positioned in any direction or orientation on the Report. Accordingly, it is intended that the appended claims cover all such variations as fall within the spirit and scope of the invention.

What is claimed:

1. A method of displaying a process, wherein the process is characterized by multiple process steps, said method comprising the steps of:
displaying a first process flow representing the process in a flow chart format on a report, wherein the first process flow represents a first characterization of the process; and
displaying a second process flow representing the process in a flow chart format adjacent the first process flow displayed on the report, wherein the second process flow represents a second characterization of the process that is different from the first characterization of the process.

2. The method of claim 1, wherein the first process flow represents a current state of the process.

3. The method of claim 2, wherein the second process flow represents a future process flow and the process steps of the future process flow are different than the process steps of the current process flow.

4. The method of claim 2, wherein the second characterization represents an optimal process flow and the process steps of the optimal process flow are different than the process steps of the current process flow.

5. The method of claim 4, wherein the process steps of the optimal process flow represent best industry practice standards, automation or new system functionality.

6. The method of claim 1, further comprising the step of displaying timing metrics for at least one process step of both the first process flow and the second process flow on the report, wherein the timing metrics are provided for a user to compare the timing metrics between the first process flow and the second process flow.

7. The method of claim 6, further comprising the step of displaying Return On Investment (ROI) metrics for the first and second process flows on the report, wherein the ROI metrics are a function of the timing metrics and are provided for a user to compare the ROI metrics between the first and second process flows.

8. The method of claim 1, wherein the process steps use different resources to facilitate completion of the process steps.

9. The method of claim 8, further comprising the step of displaying the different resources on the report using a color coded format.

10. The method of claim 1, further comprising the step of displaying a third process flow in a flow chart format adjacent the first and second process flows on the report, wherein the third process flow represents a third characterization of the process that is different from the first characterization and second characterization of the process.

11. The method of claim 1, further comprising the step of displaying the multiple process steps in a prose format.

12. The method of claim 11, further comprising the step of displaying an automation symbol adjacent at least one process step displayed in prose format, wherein the automation symbol indicates that the at least one process step is capable of being automated.

13. The method of claim 1, further comprising the step of displaying timing metrics for at least one process step adjacent at least one process step displayed in flow chart format on the report.

14. A method of defining a process step in a computer software program including a process matrix grid having a plurality of cells, wherein a series of process steps define a process flow and each process step is displayed in a row of the process matrix grid, said method comprising the steps of:
entering source data into a cell of the process matrix grid, wherein the source data identifies a resource utilized to initiate the process step;
entering action data into a cell of the process matrix grid, wherein the action data identifies an action performed in the process step;
entering resource data into a cell of the process matrix grid, wherein the resource data identifies the resource utilized to perform the process step; and
entering target data into a cell of the process matrix grid, wherein the target data identifies which resource is a beneficiary, receiver or target of the process step.

15. The method of claim 14 further comprising the step of entering timing data into a cell of the process matrix grid, wherein the timing data indicates a time to complete the process step.

16. The method of claim 15, further including the step of calculating a total time to complete the process flow by totaling the timing data of each process step of the process flow.

17. The method of claim 14 further comprising the step of defining a plurality of process steps through the process matrix grid, wherein each process step is populated in a respective row of the process matrix grid.

18. The method of claim 17 further comprising the step of joining at least one process step to a subsequent process step.

19. The method of claim 17 further comprising the step of branching one process step into at least two subsequent process steps.

20. The method of claim 14 further comprising the step of automatically displaying process flow data on a report, wherein the process flow data is illustrated in a prose format and a flow chart format on the report.

21. The method of claim 14 further comprising the step of creating a new process step by copying an existing process step.

22. The method of claim 14 further comprising the step of creating a new process flow by copying an existing process flow.

23. The method of claim 14 further comprising the step of defining an organizational hierarchy through a graphical user interface of the computer software program, wherein a process flow is a subset of a function and a function is a subset of a department of an organization, wherein the source data, resource data and target data are selected from the organizational hierarchy.

24. A computer-readable carrier including computer program instructions that cause a general purpose computer to perform the method of claim 1.

25. A computer-readable carrier including computer program instructions that cause a general purpose computer to perform the method of claim 14.
